(19) United States
(12) Patent Application Publication
(10) Pub. No.: US 2017/0214986 A1
(43) Pub. Date: Jul. 27, 2017

(54) SPEAKER MODULE AND PORTABLE ELECTRONIC DEVICE WITH SAME

(71) Applicant: Chiun Mai Communication Systems, Inc., New Taipei (TW)

(72) Inventors: FU-HSIN SUNG, New Taipei (TW); JIE-YAU TAN, New Taipei (TW); CHIA-JU LIN, New Taipei (TW)

(21) Appl. No.: 15/394,832

(22) Filed: Dec. 30, 2016

(30) Foreign Application Priority Data
Jan. 22, 2016 (CN) 201610042564.0

(51) Int. Cl. H04R 1/02

(52) U.S. Cl. CPC H04R 1/02; H04R 2499/11; H04R 2420/09

(57) ABSTRACT

A speaker module includes an earphone jack and a speaker. The earphone jack defines an earphone hole configured for receiving an earphone. The speaker is communicated with the earphone hole. Sounds emitted by the speaker are transmitted to and output from the earphone hole.

### CROSS-REFERENCE TO RELATED APPLICATIONS

This application claims priority to Chinese Patent Application No. 201610042564.0 filed on Jan. 22, 2016, the contents of which are incorporated by reference herein.

### FIELD

The subject matter herein generally relates to a speaker module and portable electronic device with the same.

### BACKGROUND

Generally, input/output (I/O) interfaces of portable electronic devices, such as a mobile phone or a personal digital assistant (PDA) are designed independently from each other. For example, a housing of the portable electronic device defines at least an earphone hole, a universal serial bus (USB) hole, a microphone sounding input hole, and a speaker output hole.

### BRIEF DESCRIPTION OF THE DRAWINGS

Implementations of the present disclosure will now be described, by way of example only, with reference to the attached figures.

FIG. 1 is an exploded, isometric view of an exemplary embodiment of a speaker module.

FIG. 2 is an assembled, isometric view of a portable electronic device with the speaker module of FIG. 1.

FIG. 3 is an assembled, isometric view of the speaker module of FIG. 1.

FIG. 4 is a cross-sectional view taken along line IV-IV of FIG. 3.

FIG. 5 is a cross-sectional view taken along line V-V of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a speaker module and a portable electronic device with the same.

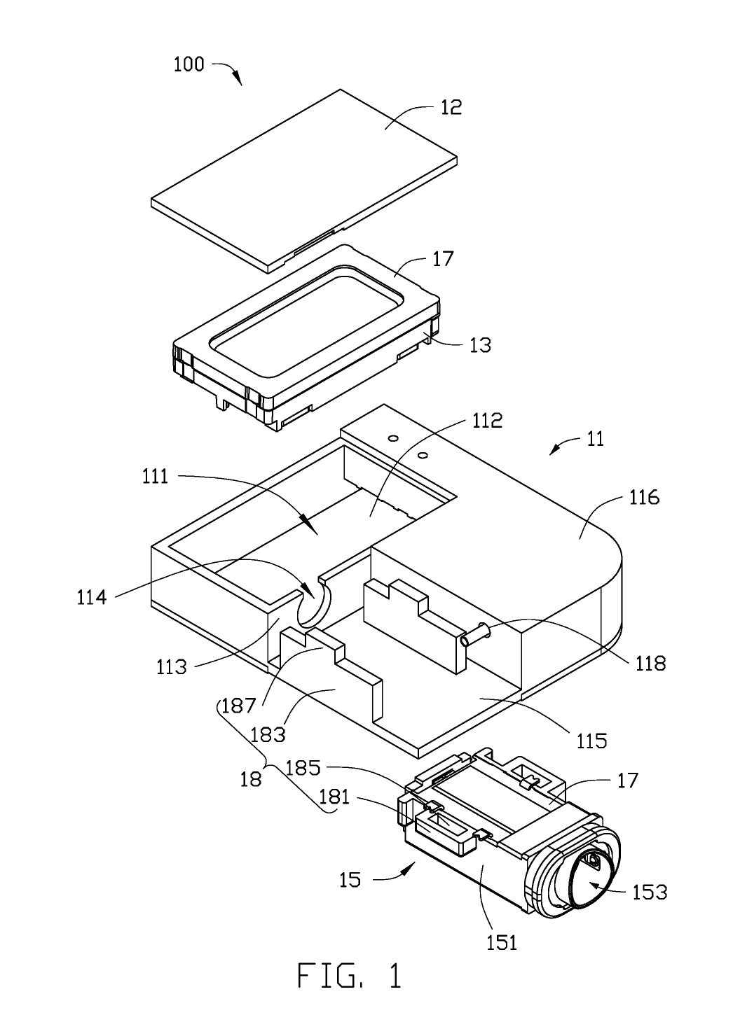

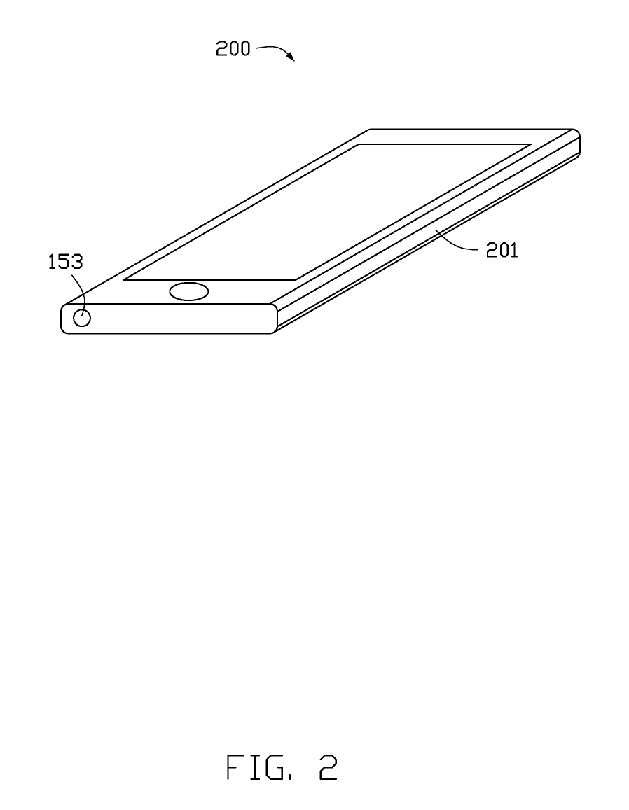

FIG. 1 illustrates an exemplary embodiment of a speaker module 100, which can be applied to a portable electronic device 200 (shown in FIG. 2). The portable electronic device 200 may be a mobile phone, a personal digital assistant (PDA) and the like.

FIG. 2 illustrates that the portable electronic device 200 includes a housing 201. The speaker module 100 is positioned in the housing 201. The speaker module 100 includes a main body 11, a cover 12, a speaker 13, and an earphone jack 15.

The main body 11 defines a receiving slot 111. The receiving slot 111 has a first end closed and a second end opened. The receiving slot 111 is configured to receive the speaker 13. In this exemplary embodiment, the receiving slot 111 includes a bottom wall 112 and a periphery wall 113. The periphery wall 113 is positioned at a periphery edge of the bottom wall 112. The bottom wall 112 and the periphery wall 113 cooperatively form the receiving slot 111. The periphery wall 113 defines a sound output hole 114. The sound output hole 114 passes through the periphery wall 113 and is communicated with the receiving slot 111. One side of the main body 11 adjacent to the sound output hole 114 defines an opening 115. One end of the main body 11 adjacent to the receiving slot 111 and the opening 115 has a closed receiving portion 116.

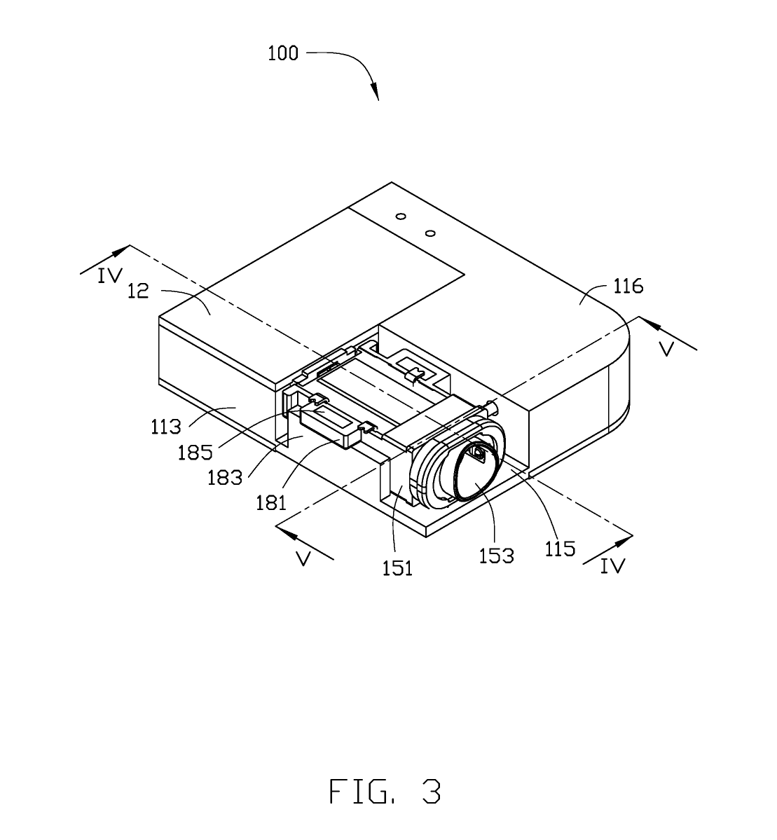

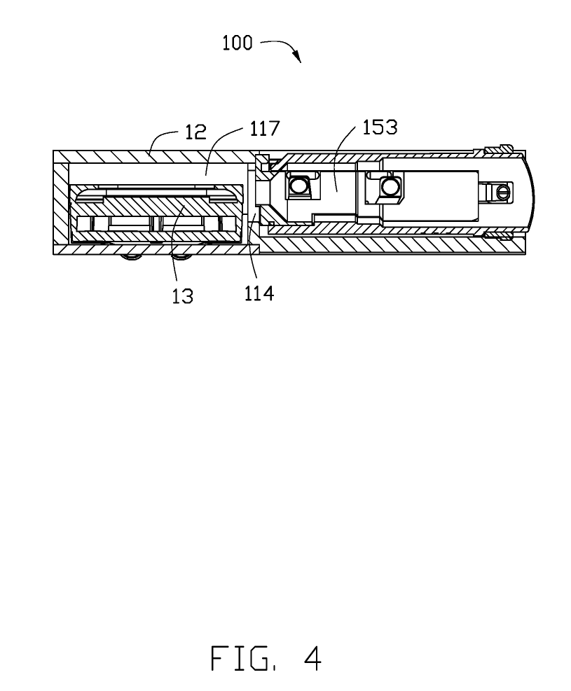

In FIG. 3, a shape and a structure of the cover 12 corresponds to the receiving slot 111. The cover 12 is positioned on the receiving slot 111 to cover an opening end of the receiving slot 111. The cover 12 and the receiving slot 111 cooperatively form a closed front sound chamber 117 (shown in FIG. 4). In this exemplary embodiment, the speaker 13 and the main body 11 are independent from each other and the speaker 13 is received in the receiving slot 111. Then, the sounds emitted by the speaker 13 can transmit to the front sound chamber 117 and output from the sound output hole 114.

It can be understood that in other exemplary embodiments, the speaker 13 can also be received in the receiving slot 111 and is integrated with the main body 11.

As illustrated in FIG. 4, the earphone jack 15 is positioned at the opening 115. The earphone jack 15 includes a main portion 151. The main portion 151 defines an earphone hole 153 configured for receiving an earphone. The earphone hole 153 passes through the main portion 151. The earphone hole 153 is exposed at an exterior of the housing 201 of the portable electronic device 200. Then an earphone plug (not shown) can be inserted to the earphone hole 153 from the outside of the housing 201. In this exemplary embodiment, the earphone hole 153 is aligned with the sound output hole 114. The earphone hole 153 is communicated with the front sound chamber 117 through the sound output hole 114. Then, when there is no earphone received in the earphone hole 153, the sound from the speaker 13 is transmitted to the earphone hole 153 through the front sound chamber 117 and the sound output hole 114, and is further transmitted to the outside of the portable electronic device 200 through the earphone hole 153. That is, the speaker 13 and the earphone jack 15 share the earphone hole 153, and the portable electronic device 200 does not need to define an additional sound output hole on the housing 201.

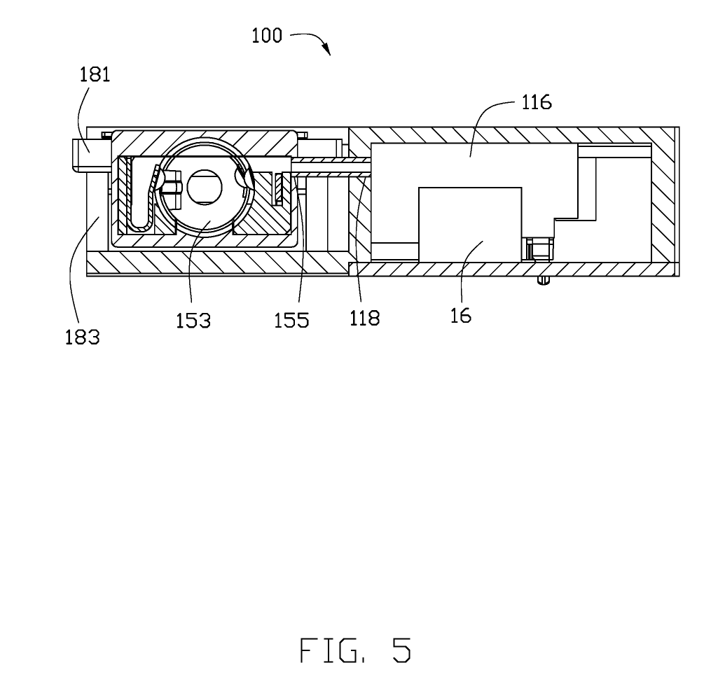

As illustrated in FIG. 5, in other exemplary embodiments, the speaker module 100 further includes a microphone 16. The microphone 16 is positioned in the receiving portion 116. One side of the receiving portion 116 defines a sound receiving hole 118. The sound receiving hole 118 is communicated with the earphone hole 153. The microphone 16 and the earphone jack 15 share the earphone hole 153, and the portable electronic device 200 does not need to define an additional sound receiving hole on the housing 201. The microphone 16 executes a sounding receiving function through the earphone hole 153 and the sound receiving hole 118.

In this exemplary embodiment, the sound receiving hole 118 is directly communicated with the earphone hole 153. For example, one side of the main portion 151 of the earphone jack 15 adjacent to the receiving portion 116 defines a connecting hole 155. The connecting hole 155 corresponds to and is communicated with the sound receiving hole 118. When the earphone hole 153 does not receive an earphone plug (not shown), a sound from the outside of the portable electronic device 200 can be transmitted to the interior of the receiving portion 116 through the earphone hole 153, the connecting hole 155, and the receiving hole 118.

In other exemplary embodiments, the sound receiving hole 118 is positioned at a side of the receiving portion 116 adjacent to the receiving slot 111. The receiving portion 116 is communicated with the front sound chamber 117 through the sound receiving hole 118. When the earphone hole 153 does not receive an earphone plug (not shown), a sound from the outside of the portable electronic device 200 can be transmitted to the interior of the receiving portion 116 through the earphone hole 153, the sound output hole 114, the front sound chamber 117, and the receiving hole 118. That is, the microphone 16 can execute the sound receiving function and the connecting hole 155 can be omitted.

As illustrated in FIG. 1, in other exemplary embodiments, when the speaker module 13 is assembled in the receiving slot 111, the speaker module 100 further includes a sealing member 17. The sealing member 17 can be a foam, a rubber, and the like. The sealing member 17 is positioned between the receiving slot 111 and the cover 12 to seal a gap between the receiving slot 111 and the cover 12. The sealing member 17 is configured to prevent sound from leaking and improve an air tightness of the front sound chamber 117.

In other exemplary embodiments, when the main portion 151 of the earphone jack 15 has an opening or a gap, the main portion 151 can also include the sealing member 17. When the sound from the speaker 13 is transmitted to the earphone hole 153 through the sound output hole 114, the sound will leak from the opening or the gap of the main portion 151 and only a portion of sound can be transmitted to the outside of the portable electronic device 200. That is, the opening or the gap of the main portion 151 will impact a sound volume of the speaker 13 transmitted to the outside. Therefore, the sealing member 17 is configured to prevent the sound from the speaker 13 to the outside of the portable electronic device 200 from leaking.

In other exemplary embodiments, the speaker 13 can also be directly positioned in the earphone hole 153. The sound from the speaker 13 is directly transmitted to the outside of the portable electronic device 200 through the earphone hole 153. Then, the receiving slot 111 and the sound receiving hole 114 can be omitted to simply a structure of the speaker module 100.

As illustrated in FIG. 1 and FIG. 3, in other exemplary embodiments, the speaker module 100 further includes a latching member 18. The latching member 18 is configured to assemble the earphone jack 15 to the main body 11. The latching member 18 includes at least one latching portion 181 and at least one fixing portion 183. In this exemplary embodiment, the latching member 18 includes two latching portions 181 and two fixing portions 183. The latching portion 181 is positioned on the main portion 151 of the earphone jack 15. The fixing portion 183 is positioned on the main body 11. It can be understood that a position of the latching portion 181 and the position of the fixing portion 183 can be exchanged.

In this exemplary embodiment, the two latching portions 181 are positioned at two sides of the main portion 151. Each latching portion 181 defines a latching hole 185. The two fixing portions 183 are positioned on the opening 115 and are configured to latch two sides of the earphone jack 15 for preventing the earphone jack 15 from shaking. One end of each fixing portion 183 includes a protruding portion 187. The protruding portion 187 passes through and is received in one latching hole 185 and the earphone jack 15 is firmly assembled to the main body 11.

In other exemplary embodiments, the latching member 18 is not limited to be above structure and can be other latching structure, for example, hook structure, it only to be ensured that the latching member 18 can firmly assemble the earphone jack 15 to the main body 11.

The exemplary embodiments shown and described above are only examples. Many details are often found in the art such as the other features of the electronic device. Therefore, many such details are neither shown nor described. Even though numerous characteristics and advantages of the present disclosure have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the exemplary embodiments described above may be modified within the scope of the claims.

What is claimed is:

1. A speaker module comprising:
an earphone jack, the earphone jack defining an earphone hole configured for receiving an earphone;
a speaker, the speaker being communicated with the earphone hole;
wherein sounds emitted by the speaker are transmitted to and output from the earphone hole.

2. The speaker module of claim 1, wherein the speaker is positioned in the earphone hole.

3. The speaker module of claim 1, further comprising a main body, wherein the main body defines a front sound chamber, the speaker is assembled in the front sound chamber and is communicated with the earphone hole.

4. The speaker module of claim 1, further comprising a main body, wherein the main body defines a front sound chamber, the speaker is integrated with the main body and is communicated with the earphone hole.

5. The speaker module of claim 3, further comprising a cover, wherein the main body defines a receiving slot, the cover is positioned on the receiving slot to cover the receiving slot, the cover and the receiving slot cooperatively form the front sound chamber, the receiving slot defines a sound output hole, the sound output hole is communicated with the earphone hole.

6. The speaker module of claim 5, further comprising a sealing member, wherein the sealing member is positioned between the receiving slot and the cover to seal a gap between the receiving slot and the cover.

7. The speaker module of claim 5, further comprising a microphone, wherein the microphone is communicated with the earphone hole and executes a sounding receiving function through the earphone hole.

8. The speaker module of claim 7, wherein the main body comprises a closed receiving portion, the microphone is received in the receiving portion, one side of the receiving portion defines a sound receiving hole, and the sound receiving hole is communicated with the earphone hole.

9. The speaker module of claim 8, wherein the sound receiving hole is defined at one side of the receiving portion adjacent to the receiving slot, the receiving portion is communicated with the front sound chamber through the sound receiving hole.

10. The speaker module of claim 8, wherein one side of the earphone jack adjacent to the receiving portion defines a connecting hole, the connecting hole corresponds to and is communicated with the sound receiving hole.

11. The speaker module of claim 4, further comprising a latching member, wherein the latching member is configured to assemble the earphone jack to the main body.

12. The speaker module of claim 11, wherein the latching member comprises at least one latching portion and at least one fixing portion, the at least one latching portion is positioned on one of the earphone jack and the main body, the at least one fixing portion is positioned on the other one of the earphone jack and the main body, the at least one latching portion defines a latching hole, the at least one fixing portion comprises a protruding portion, the protruding portion passes through and is received in the latching hole.

13. An electronic device comprising:
a housing; and
a speaker module, the speaker module positioned in the housing and comprising:
an earphone jack, the earphone jack defining an earphone hole configured for receiving an earphone;
a speaker, the speaker being communicated with the earphone hole;
wherein the earphone hole is exposed from an exterior of the housing, and sounds emitted by the speaker are transmitted to and output from the earphone hole.

14. The electronic device of claim 13, wherein the speaker module further comprises a main body, the main body defines a front sound chamber, the speaker is assembled in the front sound chamber and is communicated with the earphone hole.

15. The electronic device of claim 14, wherein the speaker module further comprises a cover, the main body defines a receiving slot, the cover is positioned on the receiving slot to cover the receiving slot, the cover and the receiving slot cooperatively form the front sound chamber, the receiving slot defines a sound output hole, the sound output hole is communicated with the earphone hole.

16. The electronic device of claim 15, wherein the speaker module further comprises a sealing member, the sealing member is positioned between the receiving slot and the cover to seal a gap between the receiving slot and the cover.

17. The electronic device of claim 15, wherein the speaker module further comprises a microphone, the main body comprises a closed receiving portion, the microphone is received in the receiving portion, one side of the receiving portion adjacent to the receiving slot defines a sound receiving hole, the receiving portion is communicated with the front sound chamber through the sound receiving hole, and the microphone executes a sounding receiving function through the earphone hole, the front sound chamber, and the sound receiving hole.

18. The electronic device of claim 15, wherein the speaker module further comprises a microphone, the main body comprises a closed receiving portion, the microphone is received in the receiving portion, one side of the receiving portion defines a sound receiving hole, one side of the earphone jack adjacent to the receiving portion defines a connecting hole, the connecting hole corresponds to and is communicated with the sound receiving hole, and the microphone executes a sounding receiving function through the earphone hole, the connecting hole, and the sound receiving hole.

19. The electronic device of claim 14, wherein the speaker module further comprises a latching member, the latching member is configured to assemble the earphone jack to the main body.

20. The electronic device of claim 19, wherein the latching member comprises at least one latching portion and at least one fixing portion, the at least one latching portion is positioned on one of the earphone jack and the main body, the at least one fixing portion is positioned on the other one of the earphone jack and the main body, the at least one latching portion defines a latching hole, the at least one fixing portion comprises a protruding portion, the protruding portion passes through and is received in the latching hole.
